(19) United States
(12) Patent Application Publication
(10) Pub. No.: US 2005/0144126 A1
(43) Pub. Date: Jun. 30, 2005

(54) System and method for implementing financing on demand service

(75) Inventors: Norris Commodore, Ridgefield, CT (US); Paul F. Crescenzo, New Canaan, CT (US); Mary J. Guimond, Darien, CT (US); Jane E. Vogt, Tokyo (JP)

Correspondence Address: Samuel A. Kassatly, 6819 Trinidad Drive, San Jose, CA, 95120, US

(73) Assignee: International Business Machines Corporation, Armonk, NY (US)

(21) Appl. No.: 10/746,402

(22) Filed: Dec. 26, 2003

(51) Int. Cl. G06F 17/60

(52) U.S. Cl. 705/40; 705/39

(57) ABSTRACT

A computer system, a service, a computer program product, and an associated method combine the ease of credit card purchases over the Internet with the flexibility of traditional leasing. The financing on demand system is a financing e-utility that prepackages customer entitlement processes, such as credit approvals, lease structures and rates, terms, and conditions with secure electronic delivery and legally enforceable document archiving, such as e-signatures. The system provides the advantage to the merchant of reducing internal administration costs, speeding up current business processes, and enhancing the ease of conducting business with end users and vendors alike. It produces secure legal enforceable documents that meet financing company requirements. Merchants provide the software for the financing on demand system to customers by software token, CD ROM, or smart card media. The system has no fixed credit limits or payment structures, is completely encrypted and secure, and uses non-proprietary open standards architecture in inputs/outputs to permit convenient integration to any vendor's Web site.

### FIELD OF THE INVENTION

The present invention generally relates to the field of commercial financing, and particularly to a software system, a computer program product, a service, and associated method to finance high value commercial sales over the Internet, that are secure, customizable, and available on demand as the customer transaction occurs. More specifically, this invention pertains to an e-business method that prepackages customer entitlement processes such as credit approvals, lease structures and rates, terms, and conditions, with secure electronic delivery and legally enforceable documents such as e-signatures, automating the traditional paper-intensive product leasing process, and providing a new way to finance products over the Internet.

### BACKGROUND OF THE INVENTION

The World Wide Web (WWW) or Internet is comprised of an expansive network of interconnected computers upon which businesses, governments, groups, and individuals throughout the world maintain inter-linked computer files known as Web pages. Originally, the Internet was devised for the transfer of information. More recently, the Internet has increasingly been used as a shopping tool for users, much like an electronic catalogue. The increasing number of Internet users purchasing products over the Internet has resulted in significant changes in the approach businesses take to product sales, converting from a standard business model to an electronic business, or e-business model.

The introduction of purchase transactions over the Internet has created a need for secure financial transactions between the customer and the e-business merchant. Numerous payment systems have been devised to accommodate the various processing needs of merchants. For example, several financing companies provide merchants with Internet merchant bank accounts, enabling them to receive credit card transactions.

These companies use a “wallet” approach for performing credit card transactions. When initiating the wallet, the consumer provides a credit card information to the financing company, typically over the Internet. In return, the consumer receives an encrypted code that refers to that credit card. When making a purchase at a participating Web merchant, the consumer provides a wallet code to the merchant. The merchant attaches that code to the purchase price and sends both to the financing company that issued the wallet. The financing company authenticates the transaction with the credit card company and then transfers the funds to the merchant along with an authorization to ship the product.

Another approach to enabling financial transactions over the Internet involves the use of a “virtual” code in lieu of the credit card number. The financing company issues the customer (or consumer) a “virtual” code in exchange for the credit card information. For security reasons, this exchange is almost always performed over the telephone, not on the Internet. Before any purchase is authorized, the financing company e-mails a confirmation request to the customer. Once the financing company receives the customer's confirmation, the credit card transaction is processed off the Internet and the merchant is sent an e-mail to authorize product shipment.

An alternate approach to credit card-based purchasing schemes is digital cash or “e-cash.” Digital cash is essentially a string of digits or tokens issued by a bank. However, to use e-cash, both the e-business merchant and the customer must have an account with a bank that issues e-cash. The bank provides both the e-business merchant and the customer with “purse” software for managing and transferring e-cash. Customers convert money from their bank accounts into e-cash then transfer it to the purse software where it is encrypted and stored on the consumer's hard drive.

When buying with e-cash, the consumer transmits the applicable tokens to the merchant who relays them to the bank for authentication and redemption. Since e-cash is not a physical object, a complex series of serial numbers is used to ensure that each e-cash “coin” can only be spent once. E-cash incurs relatively low transaction costs and provides smaller denominations than possible in other Internet financing approaches, making it suitable for use in low value transactions such as paying for a stock quote or news article. However, not many Web merchants accept e-cash and currently, relatively few banks issue it.

Electronic checking is another viable payment method used in e-commerce. An electronic check or “e-check” has essentially similar features as a paper check. In its simplest form, some systems ask the consumer to fill out an online form on the Web store. The input data is then transferred to the vendor where it is converted into a paper check by using blank check forms in a standard office printer. The check is then submitted to a bank for payment as normal.

To provide a high level of security to the customer and merchant, third party companies allow consumers to enter their checking account information at a secure site and choose a unique user name and password. A customer wishing to make a purchase from a participating Web store simply completes the merchant's online order form. The order information is then submitted to the third party's secure server where it is verified. Upon verification, the merchant prints the check and submits it to a bank. This means of electronic checking bypasses the wait for a check to clear the mail trip from the purchaser to the merchant. However, it is not as expedient as e-commerce payments using the wallet or virtual code.

All of the foregoing approaches to e-commerce transactions are targeted toward the individual making relatively small purchases typically handled by credit card transactions. The main focus in current e-commerce financing for both the user and the merchant is to provide a secure, fast transaction with minimal overhead. The purchase transaction is relatively simple, involving the transfer of money or credit from the financing company to the merchant. However, as e-commerce business models expand, e-business merchants must be able manage more complex transactions over the Internet.

In business-to-business transactions, much larger amounts of funds are involved. An e-business selling large value items over the Internet must be able to provide financing flexibility to their customers. Currently, the customer selects the desired product from the merchant, and then negotiates the price. Having secured the product the customer wants to purchase at the desired price, the customer then might wish to finance the purchase of the product. The customer then needs to get credit approval and to sign numerous documents. This entire process is relatively difficult to implement on the Internet and time consuming.

The customer may also decide that he or she would rather structure the payments to the e-business merchant through a lease agreement. However, providing a leasing option over the Internet to the customer is also relatively difficult because of the large amount of paperwork involved in setting up the lease with the customer and the financing company. Since the primary attractions of the Internet in purchase transactions are the ease in which the transaction is made and the speed at which transactions are processed, involving the large amounts of paperwork required in leasing or financing negates the advantage of the Internet for both the merchant and the customer.

What is needed is a system, a service, a computer program product, and an associated method to finance high value commercial sales over the Internet that are secure, customizable, and available on demand as the customer transaction occurs. The need for such a solution has heretofore remained unsatisfied.

### SUMMARY OF THE INVENTION

The present invention satisfies this need and presents a system, a service, a computer program product, and an associated method (collectively referred to herein as “the system” or “the present system”) for implementing a financing on demand service. The present system combines the ease of credit card purchases over the Internet with the flexibility of traditional leasing and provides a financing on demand (FOD) system.

The present system comprises a financing e-utility that comprises modular web services that are callable from Internet applications such as a shopping Web site. The e-utility prepackages customer entitlement processes such as credit decisioning, lease structures and rates, terms, and conditions with secure electronic delivery and legally enforceable document archiving of documents such as e-signatures.

The present system automates the traditional paper-intensive product leasing process and provides a new way to finance products over the Internet. The present system does not use credit cards that typically have low end lines of credit and limited payment structures, nor does it rely on off-line financing processes that negate the basic advantages of speed and convenience to Web-based transactions.

The present system provides a new way to finance high value sales over the Internet that is secure, totally customizable, and available on demand as the customer transaction occurs in real time. A feature of the present system converts a purchase price invoice to a financed periodic payment.

Conventionally, the leasing process is performed sequentially for transactions or tranches for a limited period of time to generate a detailed periodic payment. Consequently, the present system simplifies the procurement process for high volume, low cost products. The present system provides the advantage to the merchant of reducing internal administration costs, speeding up current business processes, and enhancing the ease of conducting business with end users and vendors alike.

The present system generates secure legal enforceable documents that meet financing company contracting and securitization requirements. Merchants provide access to the present system to customers by, for example, software token, CD ROM, smart card media, simple secure passwords, or other predefined secure means of identifying the entitled customer online. The present system has no fixed credit limits or payment structures, is completely encrypted and secure, and uses non-proprietary open standards architecture in inputs/outputs to permit convenient integration to any vendor's Web site. As a utility, its use can be made chargeable on a per-transaction basis, similar to the merchant fees charged by credit card issuing banks.

Currently, business-to-business information technology (IT) transactions occurring over the Web, except for small deals paid by credit or procurement cards, are financed off-line after the order has been placed. Product financing is a limiting and relatively manually intensive after-the-fact step to Web sales processes.

The present system provides secure, instant entitled lines of credit in addition to customized lease structuring and payment plans pre-agreed by each customer at the point of checkout or invoicing. Customers invoke their encrypted identity to execute a document online. All other supporting documentation is produced and archived on the present system and is available on demand, without further vendor or customer interaction required at the time of the transaction.

The present system provides distinct advantages over current financing methods to merchants, customers, and financing companies. For the vendor, the present system provides enhanced ease of product sales through greatly expanded credit access, financial structuring prearranged for each customer, and accelerated invoice settlement for the financing source. For the customer, the present system provides the convenience of customized financing and credit lines available at his/her demand over the Internet plus secure document tracking and archiving. For the financing company, the present system provides reduced paperwork, enhanced productivity, broadened access to new business-to-business markets over the Internet, and additional fee income for managing the financing on demand processes.

Typical customers of the financing company are those that have a term lease master agreement (TLMA) or a customer based master agreement (CBMA). These are lease agreements that have negotiated terms and conditions. Periodically, usually quarterly, these customers negotiate renewed lease rates with the financing company. While dollar amounts are financed, credit extensions are fixed based on underwriting rules at transaction time.

Once the lease rates are set for the quarter, the customer and the financing company execute a rate supplement to their base term lease master agreement (“TLMA”). The lessor notifies the merchant of the customer's entitled terms, usually the amount of credit extended. The customer contacts the merchant, who then issues invoices for the product to the financing company after shipping the product to the customer. The financing company issues a delivery confirmation document to the customer to sign and acknowledge receipt of the product and initiation of the underlying lease.

The present system is based on the concept of “reconciliation up front.” Customers approve rate supplements and delivery confirmations with the present system prior to purchasing products, creating the legal agreement to set up leases. Customer acceptance of delivery confirmation initiates the equipment lease and permits the lessor to execute settlement of the merchant's invoice.

Delivery confirmations are assumed accepted after a specified period unless the customer takes action to reject payment based on pre-agreed reasons (such as mis-pricing). The present system displays to the customers a detailed supplement that indicates how their invoices will be financed on a monthly basis. A feature of the present system is that once invoices are released to the customer, the rest of the financing process is automatic. The invoice is the start of the lease or other financing arrangement between the customer and the financing company.

Master agreements tend to be static while underlying supplements to the master agreement vary by transaction (with transaction specific details such as pricing, term, payment structure, validity etc.). Quarterly summary supplements specify quarterly agreed-to rates. Delivery confirmation/detailed supplements are generated from merchant invoices for products shipped in the quarter. These supplements convert invoice purchase prices to monthly lease rents due using the rates of the summary supplement valid for the quarter.

The present system presents master term lease contracts, summary supplements and any associated documentation (Schedule A), the delivery confirmation/detailed supplements, and merchant invoices to the entitled customer at the appropriate time for review and secure electronic signing. All such documents are treated as legal documents, signed electronically by both parties in a secure fashion in accordance with local laws, archived by the system, and made available for later securitization by the financing company or for online search and retrieval by the signing parties.

The present invention may be embodied in a utility program such as a financing on demand consumer utility program. The present invention provides means for the customer to approve rate supplements and delivery confirmations with the utility program prior to purchasing products, creating the legal agreement to set up leases. Customer acceptance of delivery confirmation initiates the equipment lease and permits the lessor to execute settlement of the merchant's invoice. Customers obtain access to merchants by, for example, software token, CD ROM, smart card media, simple secure passwords, or other predefined secure means of identifying the entitled customer online. Customers further obtain secure, instant entitled lines of credit in addition to customized lease structuring and pre-agreed payment plans. Customers invoke their encrypted identity to execute a document online. All other supporting documentation is produced and archived on the present system and is available on demand by the customer.

The present invention may be embodied in a utility program such as a financing on demand merchant utility program. The present invention provides means for the merchant to reduce internal administration costs, speed up current business processes, and enhance the ease of conducting business with end users and vendors alike. The merchant receives notification of the customer's entitled terms, usually the amount of credit extended. The merchant obtains enhanced ease of product sales through greatly expanded credit access, financial structuring prearranged for each customer, and accelerated invoice settlement for the financing source.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a system and method for implementing financing on demand of the present invention can be used;

FIG. 2 is process flowchart illustrating a method of operation of the financing on demand system of FIG. 1;

FIG. 3 is an exemplary high-level hierarchy of the system and method of FIGS. 1 and 2;

FIG. 4 is a process flowchart illustrating a method of creation of a customer's entitlement and master agreement, using the financing on demand system and method of the present invention;

FIG. 5 is a process flow chart illustrating the manner in which a customer places an order on the financing on demand system of present invention;

FIG. 6 is comprised of FIGS. 6A and 6B, and represents a process flowchart that illustrates a method by which products are ordered and placed on lease; and

FIG. 7 a process flowchart that portrays a UCC-1 filing and billing example, using the financing on demand system and method of the present invention.

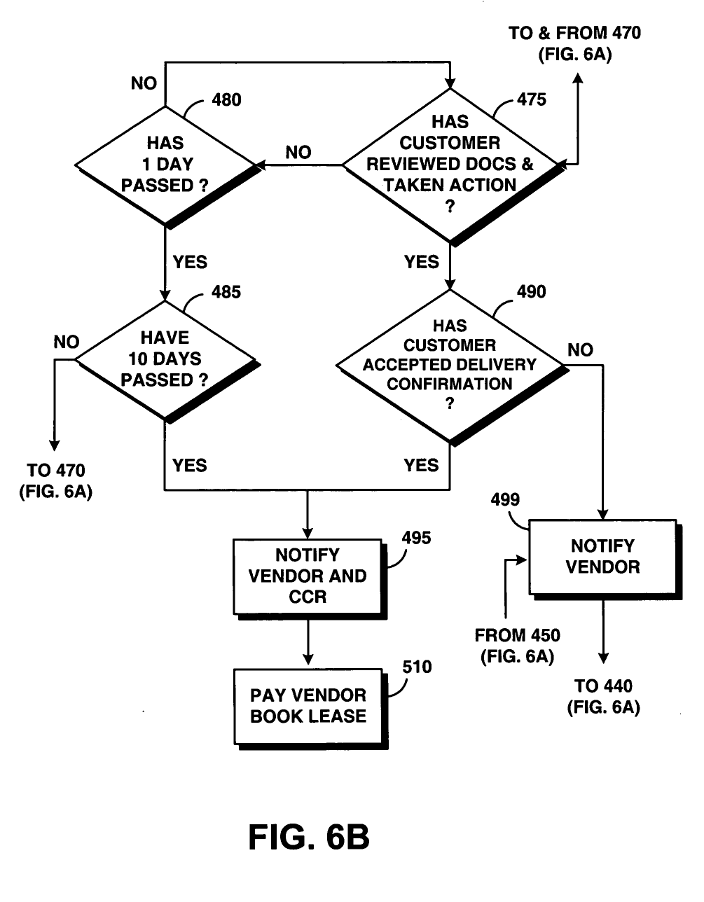

### DETAILED DESCRIPTION OF PREFERRED EMBODIMENTS

The following definitions and explanations provide background information pertaining to the technical field of the present invention, and are intended to facilitate the understanding of the present invention without limiting its scope:

EDI: Electronic Data Interchange. An electronic communication of business transactions such as orders, confirmations and invoices, between organizations.

Internet: A collection of interconnected public and private computer networks that are linked together with routers by a set of stand protocols to form a global distributed network.

PDF: Portable Document Format—the page description language used in the Acrobat document exchange system designed to be portable across computer platforms. Two major advantages for utilizing this format are that there are numerous freeware PDF readers available on the Internet and that PDF documents cannot be altered without the source document.

UCC-1 Filing: An entry in the Uniform Commercial Code designed to give public notice corresponding to the debtor-secured party association and the security involved. Furthermore, the UCC-1 records and protects a secured party's interest in the security offered by a debtor for a loan.

URL (Uniform Resource Locator): A unique address that fully specifies the location of a content object on the Internet. The general format of a URL is protocol://server-address/path/filename.

Web Site: A database or another collection of inter-linked hypertext documents (“Web documents” or “Web pages”) and associated data entities, which is accessible via a computer network, and which forms part of a larger, distributed informational system such as the WWW. In general, a Web site corresponds to a particular Internet domain name, and includes the content of a particular organization. Other types of Web sites may include, for example, a hypertext database of a corporate “Intranet” (i.e., an internal network which uses standard Internet protocols), or a site of a hypertext system that uses document retrieval protocols other than those of the WWW.

World Wide Web (WWW): An Internet user—server hypertext distributed information retrieval system.

XML: extensible Markup Language. A standard, semi-structured language used for Web documents. During a document authoring stage, XML “tags” are embedded within the informational content of the document. When the Web document (or “XML document”) is subsequently transmitted by a Web server to a Web browser, the tags are interpreted by the browser and used to parse and display the document. In addition to specifying how the Web browser is to display the document, XML tags can be used to create hyperlinks to other Web documents.

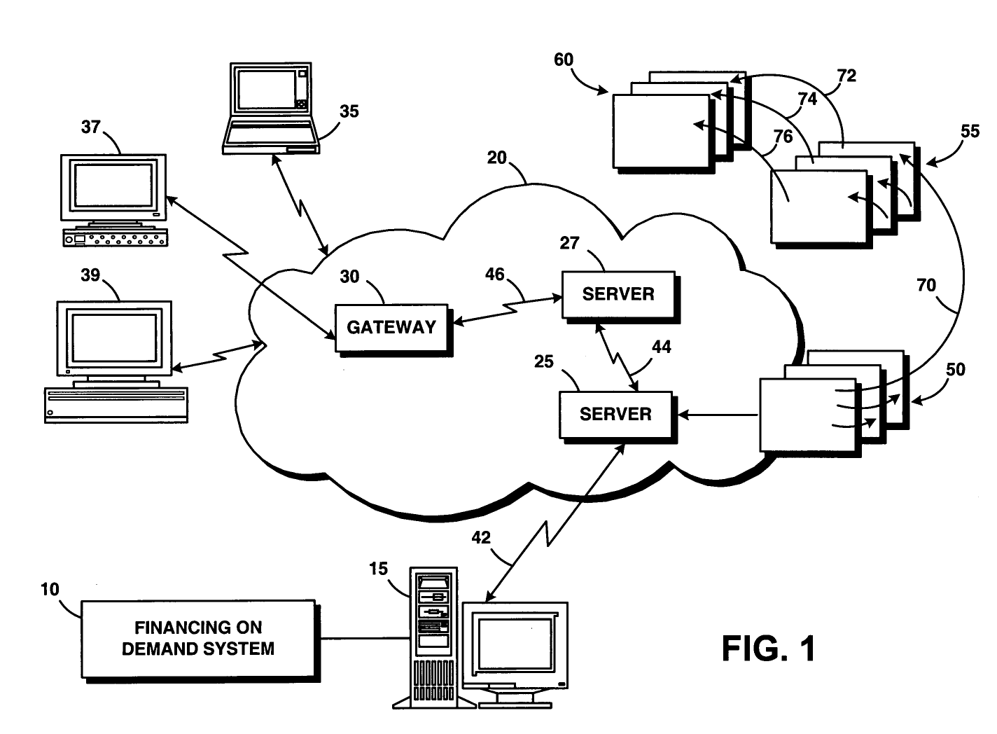

FIG. 1 portrays an exemplary overall environment in which a system, a service, a computer program product, and an associated method (“the system 10”) for implementing financing on demand according to the present invention may be used. The financing on demand system 10 includes a software programming code or computer program product that is typically embedded within, or installed on a host server 15. Alternatively, system 10 can be saved on a suitable storage medium such as a diskette, a CD, a hard drive, or like devices. While system 10 will be described in connection with the WWW, system 10 can be used with a stand-alone database of terms that may have been derived from the WWW or other sources.

The cloud-like communication network 20 is comprised of communication lines and switches connecting servers such as servers 25, 27, to gateways such as gateway 30. The servers 25, 27 and the gateway 30 provide the communication access to the WWW or Internet. Users, such as remote Internet users, are represented by a variety of computers such as computers 35, 37, 39, and can query the host server 15 for desired information through the communication network 20. Computers 35, 37, 39 each include software that will allow the user to browse the Internet and interface securely with the host server 15.

The host server 15 is connected to the network 20 via a communications link 42 such as a telephone, cable, or satellite link. The servers 25, 27 can be connected via high-speed Internet network lines 44, 46 to other computers and gateways. The servers 25, 27 provide access to stored information such as hypertext or Web documents indicated generally at 50, 55, and 60. The documents 50, 55, 60 may comprise text, images, and other objects. The hypertext documents 50, 55, 60 most likely include embedded hypertext links to other locally stored pages and hypertext links 70, 72, 74, 76 to other Web sites or documents 55, 60 that are stored by various Web servers such as the server 27.

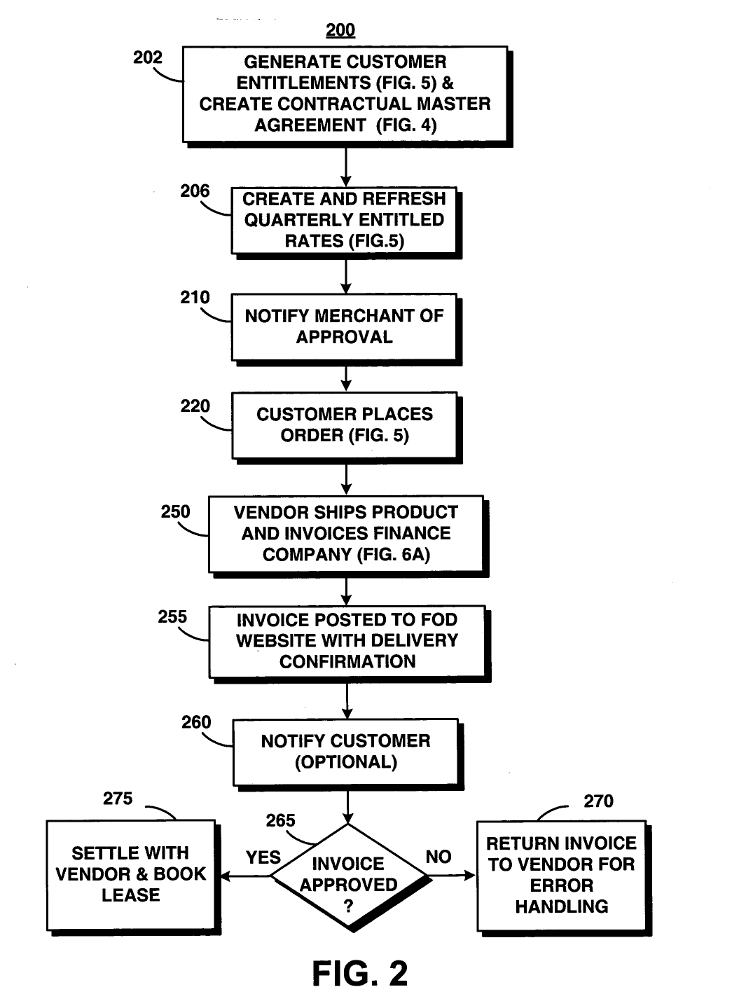

FIG. 2 illustrates a service method 200 of the present invention, according to which a customer purchases products from a vendor using financing from system 10. The customer's entitlement is first established with system 10.

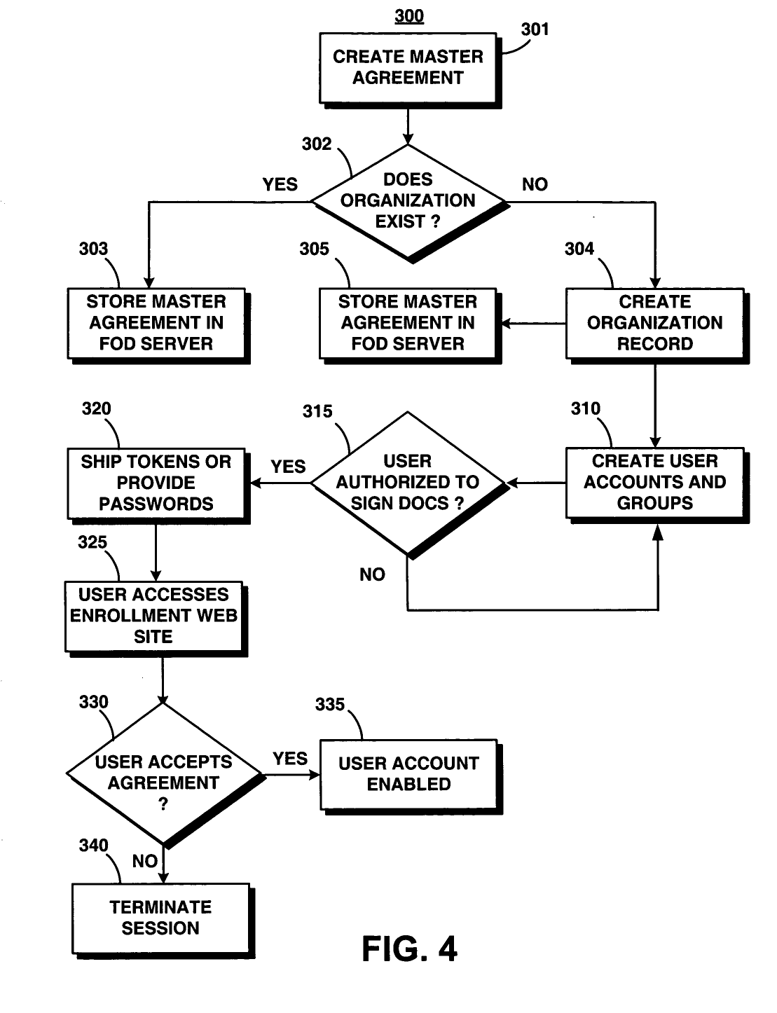

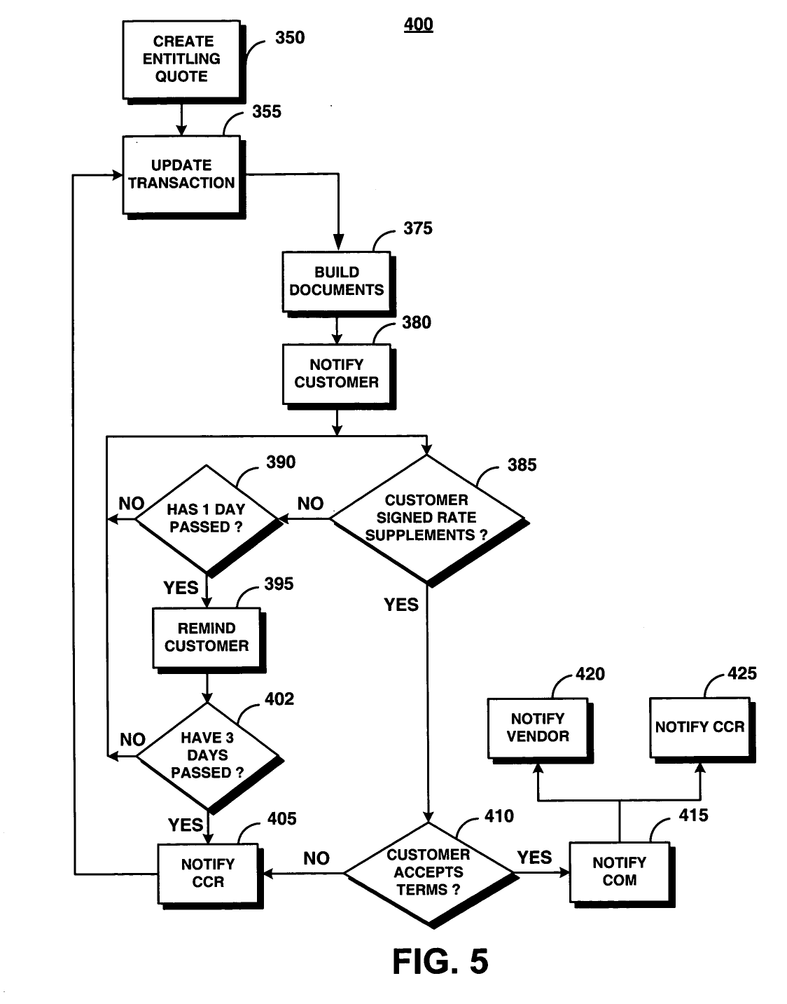

In step 202, the customer interacts with the financing company to establish his/her master agreement, as detailed in service method 300 of FIG. 4, below. The customer's entitlements are also created, as detailed in service method 400 of FIG. 5, below. The customer's entitlement includes his credit limit, financing terms and conditions, his desires for payment term and structure, payment tracking, and payment statement preferences.

When dealing with a financing company, the customer will typically renegotiate financing rates and/or payment structures on a periodic basis such as quarterly. Service method 400 will repeat on this periodic basis, to refresh the customer's entitlements (step 206). These financing terms and the refinancing period are also included in the customer's entitlement. Step 202 is performed using standard documents such as documents 50, 55, 60, presented online via host server 15 and accepted by the customer. The customer's account is then enabled.

The financing company then notifies the merchant of the customer's credit approval in step 210.

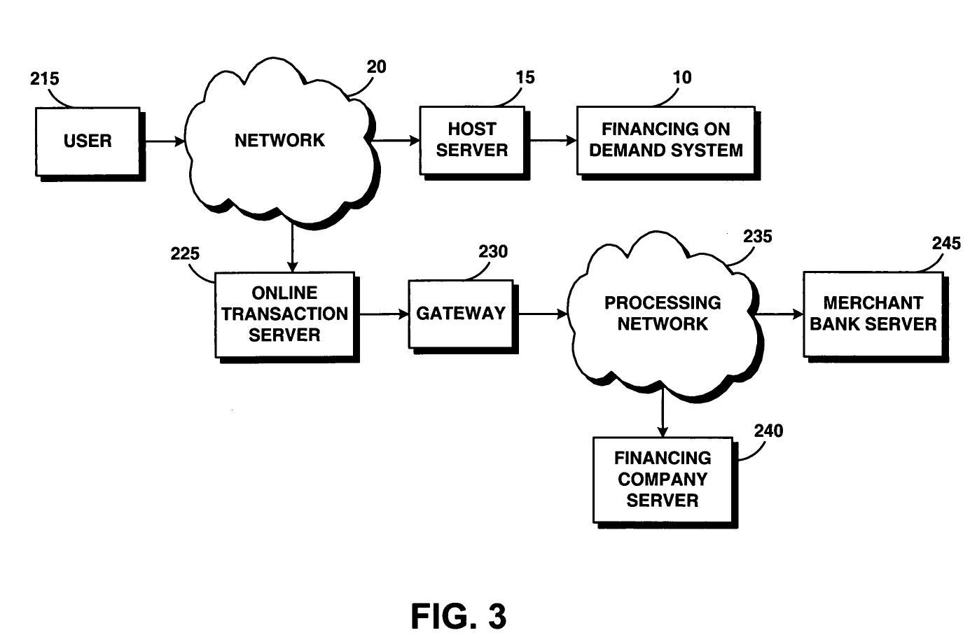

With further reference to the example of FIG. 3, an entitled customer, (the “user”) 215 accesses a merchant's Web site on host server 15. User 215 decides to purchase a product and places an order in step 220 (FIG. 2). The merchant's Web site on host server 15 provides user 215 with access to system 10 as a method of payment.

As user 215 checks out his shopping cart, user 215 selects a financing option available to him/her on the merchant's Web site on host server 15 from system 10. System 10 directs user 215 to the online transaction server 225 (FIG. 3), where the financial and billing information of user 215 is encrypted. User 215 can view quarterly rates for the eligible products in his shopping cart prior to checkout.

Once the order is placed, the invoice information is sent through a private gateway 230 to a processing network 235. The processing network 235 routes the invoice information to the financing company server 240 of the financing company. The merchant ships products to the entitled user 215 of value up to the entitled credit limits of user 215 (step 250) and invoices the financing company under the terms of the financing company lease authorization/purchase order received earlier.

The merchant invoice is used to create the delivery confirmation document. Both the merchant invoice and the delivery confirmation document are made available for review and acceptance by user 215 on the merchant's Web site (step 255) on host server 15. In an embodiment, system 10 may notify user 215 in step 260 that the invoice has been posted.

User 215 has a predetermined period of time in which to review and accept the invoice before the invoice is automatically approved. User 215 then reviews the invoice and either approves or rejects the invoice in step 265.

If user 215 rejects the invoice, system 10 returns the invoice to the merchant for error handling in step 270. Otherwise, system 10 converts the invoice to periodic payment statements. In step 275, the financing company settles the merchant invoice in full and the lease or financing plan is booked as pre-arranged between user 215 and the financing company. If the purchased product is leased, then the asset title passes to the financing company that retains title of the asset until any decisions are made by user 215 at the end of lease.

A service method 300 for creating the master agreement transaction of user 215 (step 202) in system 10 is illustrated in more detail by the flowchart of FIG. 4. An employee at the financing company logs into system 10 in step 301 and requests the creation of a master agreement transaction for the organization of user 215. Prior to this action, user 215 or his or her organization has already received a customer entitlement from the financing company, as represented by step 202 (FIG. 2). These customer entitlements comprise a line of credit and lease quotation, terms and conditions, etc., which initially have been negotiated in person and presumably meet the business needs of user 215.

System 10 searches its records for the listing of the organization in step 302. If the organization exists in step 302, system 10 stores the master agreement in the host server 15 (step 303). If the organization does not exist in the records of system 10, the employee creates a record for the organization in step 304 and enters the organization's information from the customer's entitlement.

System 10 then stores the master agreement in host server 15, in step 305. Next, the financing company employee creates user accounts and user groups in step 310, again based on the information provided by user 215 in step 202. If system 10 verifies in step 315 that user 215 is authorized to sign documents for their organization, the financing company electronically transfers credit access tokens or a secured password to the designated receipt location of user 215 at step 320, requesting a return receipt on the token transfer. Access tokens may be physically mailed or sent by email to the authorized user 215. If user 215 is not authorized to sign documents, no token is mailed.

User 215 is able to access his or her user enrollment Web site in step 325 by using his or her account, default password, and security code. The user enrollment Web site displays the user master agreement. If user 215 declines the user agreement in step 330, system 10 terminates the session in step 340. If user 215 accepts the agreement in step 330, the entitled account of user 215 is enabled in step 335 by system 10. The merchant is notified that the master agreement account of user 215 is now enabled (Step 210). It is expected that service method 300 and service method 400 below occur in most cases concurrently at the initial enrollment of user 215.

Service method 400 of creating entitlements and refreshing them periodically for user 215 in step 206 of FIG. 2 is illustrated in more detail by the flowchart of FIG. 5. The quote includes the contractual details of the lease with a particular user 215 and is comprised of several parts containing the user name, address, approved credit limits, products eligible to be financed, negotiated lease rates and terms/payment structures, and any special terms and conditions associated with the master agreement.

The entitlement process begins when the financing company creates an entitling quote at step 350. First, the financing on demand (FOD) account for user 215 is created or updated (e.g., quarterly renewal) in step 355 with information supplied by the entitling quote in XML format. To update the transaction in system 10, the financing company's representative logs onto system 10, creates a new quote transaction, confirms credit limits and other contract data needed by the financing company to execute leasing transactions for user 215, and loads them into system 10 using standardized XML formats.

In step 375, system 10 generates pertinent lease documents. System 10 builds the periodic summary rate supplement and associated list of eligible equipment (schedule A) for this quote. The rate supplement lists the lease rate for categories of products. Schedule A defines the type of equipment within each category. Lease rates and schedule A are thus fixed for all transactions for the coming quarter. The financing company customer contract representative inputs the schedule A once per quarter and system 10 stores it for use in all quote transactions during the quarter.

At step 380, system 10 notifies the user 215 via e-mail as requested. The notice contains the URL for the Web site of system 10 and the quote number needed to access the rate supplement. User 215 is notified by the system 10 that his/her entitlements are established for user 215 and are ready for user 215 to confirm his/her acceptance. User 215 accepts his/her entitlements online with his/her secure account access and e-signature capability provided by system 10.

At step 385, system 10 checks if user 215 has signed the rate supplement. If the rate supplement has not been signed, system 10 checks in step 390 how long the supplement has been waiting for a signature. If a predetermined period, such as one day, still has not elapsed, system 10 returns to step 385 and waits for the signature of user 215.

If, however, one day has elapsed (step 390), system 10 sends a reminder to user 215 in step 395 that a signature is required on the rate supplement, and checks in step 402 if an extended (or maximum) period of time, such as three days, have elapsed. If not, system 10 returns to step 385 and waits for the client's signature. Steps 385 to 402 are repeated until three days have elapsed or a signature is provided by user 215. During those three days, a reminder is sent periodically to user 215, i.e., three times, once per day, etc.

If three days have passed without a signature, system 10 notifies the customer contract representative (CCR) in step 405. System 10 informs the customer contract representative that user 215 rejected the agreement by declining to sign the rate supplement after three notices as determined at step 402.

When notified in step 380 that a summary rate supplement is waiting for authorization at the financing on demand Web site of user 215, user 215 logs onto system 10 and accesses the summary rate supplement document. System 10 presents a list of quote transactions requiring the attention of user 215.

User 215 retrieves the appropriate summary rate supplement, schedule A to the rate supplement, and any addenda. User 215 in step 410 may accept the terms of the summary rate supplement by e-signing the summary rate supplement and addenda. User 215 may also decline the terms of the rate supplement by not signing the rate supplement or by informing the financing company of the reasons for rejecting the terms.

If user 215 declines the terms, system 10 notifies the customer contract representative in step 405, and indicates the reasons as supplied by user 215 in step 410. The financing company customer contract representative then accesses system 10 to update the quote transaction. The customer contract representative obtains an updated new summary supplement and/or addendum that retains the same quote number and returns to step 355 to repeat the process, if necessary.

If user 215 accepts the quote and its terms, system 10 e-mails a notice to the customer operations manager (COM) in step 415, informing the financing company's customer operations manager that user 215 accepted the summary rate supplement and any addenda. Then, the financing company's customer operations manager retrieves the documents from system 10, reviews the document, and counter-signs the documents, if required.

At step 420, system 10 sends a notice to each vendor whose rate supplements the user 215 has signed. The notice comprises the credit limit of user 215, the quote number, and the list of products. System 10 derives the information sent to the vendor from the quote document and the schedule A document. Vendors do not have access to system 10 and receive all of their information via this notice. Each vendor receives the equivalent of a lease authorization letter via e-mail. In addition, system 10 sends a notice to the customer contract representative (CCR) in step 425 that user 215 did accept the rate supplement.

The above process is repeated periodically (quarterly), re-pricing rates, recreating the Schedule A list of equipment to be leased, reviewing credit line status and re-advising vendors of available credit.

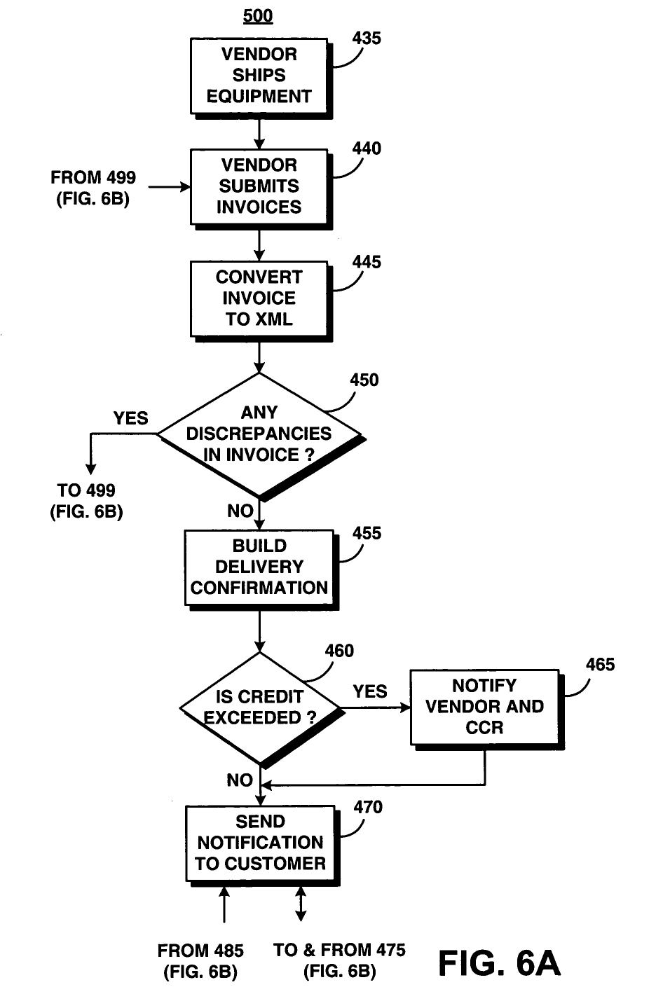

FIG. 6 (FIGS. 6A and 6B) describes in more detail a service method 500 followed by the financing company to initiate equipment leases and settle associated merchant invoices, as illustrated in step 250 and following of FIG. 2. Following step 420 of FIG. 5, where the vendor is notified that user 215 has accepted the financing on demand terms, the vendor ships the ordered product in step 435.

In step 440, the vendor submits invoices in electronic format to the financing company. Each invoice includes the quote number to properly identify the lease agreement under which the product is financed. The electronic invoices are submitted to the same system at the financing company that is currently used or in place. The transactions for financing on demand are selected out of the general pool of incoming invoiced transactions.

The invoices are then converted to an XML format in step 445 and transferred to system 10. In step 450, system 10 checks for any discrepancy in the quote number, type validity, or model numbers. If the invoice and the quote are reconciled, system 10 continues to step 455, where system 10 places the XML invoice documents into the correct transaction based on the quote number contained in each transaction. System 10 builds the delivery confirmation document from the invoice document in step 455.

In step 460, system 10 determines the status of the credit limit of user 215. If the limit is exceeded, system 10 notifies the vendor and the customer contract representative (CCR) in step 465 that the credit limit of user 215 is exceeded.

If the credit limit of user 215 is not exceeded (step 460), system 10 e-mails the user 215 in step 470 a notice containing the URL for the financing on demand Web site and the quote number as a reminder to access the delivery confirmation. System 10 then verifies that user 215 has signed the delivery confirmation in step 475 (FIG. 6B).

If the delivery confirmation has not been signed, system 10 checks at step 480 how long the supplement has been waiting for a signature. If a first period, i.e., a day, has not elapsed, system 10 returns to step 475 and waits for the signature of user 215.

If a day has elapsed (step 480), system 10 checks in step 485 if a predetermined maximum period of time, e.g., ten days, have elapsed. If not, system 10 returns to step 470, and sends another delivery confirmation request to user 215. Steps 470 to 485 are repeated until ten days have elapsed or a signature has been provided by user 215. During those ten days, notifications are periodically sent to user 215, for example ten times, once per day, etc. Each subsequent notice contains a different text emphasizing that failure to sign the delivery confirmation will result in accepting delivery of the product. If the user 215 fails to sign the delivery confirmation after 10 days, system 10 continues to step 495.

If at steps 475 and 490, system 10 determines that user 215 has signed the documents and accepted the delivery confirmation, system 10 then notifies the corresponding vendor in step 495. If the user 215 does not accept a delivery confirmation document, system 10 notifies the corresponding vendor in step 499. System 10 also notifies the vendor in step 499 if there are any discrepancies found in the invoice in step 450.

At step 499, system 10 informs the vendor of any errors in invoicing, short shipment, or mis-delivery, etc. that have caused rejection of the delivery confirmation document by user 215. The vendor addresses all issues of discrepancy as notified in step 450 and submits new, corrected invoices as before, in step 440.

At step 495, system 10 also places a notice into the quote transaction system indicating that the user 215 has acknowledged the delivery confirmation either by default at step 485, or by accepting the delivery confirmation in step 495. System 10 notifies the financing company customer contract representative and operations manager and decrements available credit. The customer operations manager countersigns, if required.

At step 510, the lease is booked as an executed transaction in the lease quotation system and settlement is initiated with the merchant. System 10 builds the UCC-1 filing information into a record and passes this record to an external service that handles UCC-1 filings. The transaction documents are archived in an online database that is available to entitled users. Entitled users can browse and retrieve signed documents up to several years old, depending on local legal archival requirements.

An example that illustrates the performance of system 10 will now be described with reference to FIG. 2. An e-commerce client, who desires the convenience of lease structuring, approaches the financing company with a particular financing need. The client has a product he or she wishes to purchase, such as a fleet of tractors and knows that each tractor will cost $10,000. The product is available from a vendor on the Internet. The client needs ten tractors over a six month period.

The client negotiates with the financing company that offers financing on demand using system 10. System 10 prepackages client entitlement processes that include credit approvals, lease structures and rates, and terms and conditions. At step 202, the financing company assesses the client's credit based on the information provided by the customer and produces a credit financing entitlement. Both parties agree to rate terms and conditions of financing and the financing company generates the customer entitlements.

The tractor merchant's online Web site by prior agreement has already integrated online financing from system 10. System 10 now notifies the tractor merchant of the client's entitlements. Unlike the case of credit card purchases and lease agreements, the tractor merchant is made aware of the client's credit worthiness before the customer places an order. With system 10, the tractor merchant has the opportunity for greater sales through expanded credit access and financial structuring.

At step 220, the client decides to proceed with the purchase of several tractors, authorizing the vendor to ship the tractors under lease to the financing company. The tractors are all shipped to the customer and invoiced to the financing company. The financing company presents the invoices and delivery confirmation on line to the client who confirms delivery (step 265). The financing company pays the vendor for the tractor in step 275. The vendor benefits from the accelerated invoice settlement. The prearranged financial structuring may differ from client to client, but it is transparent to the tractor merchant.

The purchase price is converted into a lease in step 250 based on the agreement between the financing company and the user 215 in step 202. For example, the $10,000 invoice may be financed over a period of 36 months. The financing company posts the invoice with delivery confirmation and detailed lease information on the client's financing on demand Web page in step 255 and sends him or her a notice to that effect.

Contingent on the client's acceptance of the invoice terms, the client would pay the financing company in monthly installments as for conventional leases. The lease structure offers the client the convenience of custom-tailored financing and credit lines available on his or her demand over the Internet via secure document tracking and archiving. Should there be any dispute over the purchased goods or the invoice, the financing company alerts the vendor in step 270.

It is to be understood that the specific embodiments of the invention that have been described are merely illustrative of certain application of the principle of the present invention. Numerous modifications may be made to the system and method for implementing financing on demand service invention described herein without departing from the spirit and scope of the present invention. Moreover, while the present invention is described for illustration purpose only in relation to the WWW, it should be clear that the invention is applicable as well to a commercial financing system accessible through any adequate network.

1. A method for automatically customizing the implementation of a financing on demand transaction over a network, to provide enhanced ease of product sales through greatly expanded credit access and financial structuring that is prearranged for each customer in addition to accelerated invoice settlement, the method comprising:
automatically generating a customer's entitlement;
automatically creating a master agreement transaction based on the customer's entitlement;
automatically notifying a financing company and a merchant of a customer's credit approval;
automatically posting a corresponding invoice on a network when a customer transaction is approved; and
automatically notifying the customer that the invoice has been posted for the customer's approval.

2. The method according to claim 1, wherein generating the customer's entitlement comprises generating terms and conditions on a periodic basis.

3. The method according to claim 2, wherein generating the terms and conditions on a periodic basis comprising generating the terms and conditions on a quarterly basis.

4. The method according to claim 1, wherein the customer's entitlement comprises a customer's credit limit.

5. The method according to claim 1, wherein the customer's entitlement comprises a customer's financing terms and conditions.

6. The method according to claim 1, wherein the customer's entitlement comprises a customer's desire to obtain a supplemental payment.

7. The method according to claim 1, wherein the customer's entitlement comprises a customer's payment tracking.

8. The method according to claim 1, wherein the customer's entitlement comprises a customer's payment statement preference.

9. The method according to claim 1, wherein the master agreement transaction is created by a financing company.

10. The method according to claim 1, wherein a finance on demand server posts the corresponding invoice on the network.

11. The method according to claim 9, wherein automatically creating the master agreement transaction comprises generating secure legal enforceable documents that meet the financing company's contracting and securitization requirements.

12. The method according to claim 1, further comprising the customer approving a rate supplement and a delivery confirmation prior to purchasing a product; and
wherein the customer acceptance of the delivery confirmation initiates an equipment lease and permits the customer to execute a settlement of a merchant's invoice.

13. The method according to claim 12, further comprising displaying to the customer a detailed supplement that indicates how the customer's invoice will be financed on a periodic basis.

14. A computer program product having instruction codes embedded on a medium for automatically customizing the implementation of a financing on demand transaction over a network, to provide enhanced ease of product sales through greatly expanded credit access and financial structuring that is prearranged for each customer in addition to accelerated invoice settlement, the computer program product comprising:
a first set of instruction codes for automatically generating a customer's entitlement;
a second set of instruction codes for automatically creating a master agreement transaction based on the customer's entitlement;
a third set of instruction codes for automatically notifying a financing company and a merchant of a customer's credit approval;
a fourth set of instruction codes for automatically posting a corresponding invoice on a network when a customer transaction is approved; and
a fifth set of instruction codes for automatically notifying the customer that the invoice has been posted for the customer's approval.

15. The computer program product according to claim 14, wherein the first set of instruction codes generates terms and conditions on a periodic basis.

16. The computer program product according to claim 14, wherein the customer's entitlement comprises a customer's credit limit.

17. The computer program product according to claim 14, wherein the customer's entitlement comprises a customer's financing terms and conditions.

18. The computer program product according to claim 14, wherein the customer's entitlement comprises a customer's desire to obtain a supplemental payment.

19. The computer program product according to claim 14, wherein the customer's entitlement comprises a customer's payment tracking.

20. The computer program product according to claim 14, wherein the customer's entitlement comprises a customer's payment statement preference.

21. The computer program product according to claim 14, wherein a finance on demand server posts the corresponding invoice on the network.

22. The computer program product according to claim 14, wherein the master agreement transaction comprises secure legal enforceable documents that meet a financing company's contracting and securitization requirements.

23. The computer program product according to claim 14, further comprising a sixth set of instruction codes for displaying to the customer a detailed supplement that indicates how the customer's invoice will be financed on a periodic basis.

24. A system for automatically customizing the implementation of a financing on demand transaction over a network, to provide enhanced ease of product sales through greatly expanded credit access and financial structuring that is prearranged for each customer in addition to accelerated invoice settlement, the system comprising:
means for automatically generating a customer's entitlement;
means for automatically creating a master agreement transaction based on the customer's entitlement;
means for automatically notifying a financing company and a merchant of a customer's credit approval;
means for automatically posting a corresponding invoice on a network when a customer transaction is approved; and
means for automatically notifying the customer that the invoice has been posted for the customer's approval.

25. The system according to claim 24, wherein the first means generates terms and conditions on a periodic basis.

26. The system according to claim 24, wherein the customer's entitlement comprises a customer's credit limit.

27. The system according to claim 24, wherein the customer's entitlement comprises a customer's financing terms and conditions.

28. The system according to claim 24, wherein the customer's entitlement comprises a customer's desire to obtain a supplemental payment.

29. The system according to claim 24, wherein the customer's entitlement comprises a customer's payment tracking.

30. The system according to claim 24, wherein the customer's entitlement comprises a customer's payment statement preference.

31. The system according to claim 24, wherein a finance on demand server posts the corresponding invoice on the network.

32. The system according to claim 24, wherein the master agreement transaction comprises secure legal enforceable documents that meet a financing company's contracting and securitization requirements.

33. The system according to claim 24, further comprising a sixth means for displaying to the customer a detailed supplement that indicates how the customer's invoice will be financed on a periodic basis.

34. A financing on demand service for automatically customizing the implementation of a transaction over a network, the service comprising:
automatically generating a customer's entitlement;
automatically creating a master agreement transaction; and
automatically notifying a financing company and a merchant of a customer's credit approval,
to provide enhanced ease of product sales through greatly expanded credit access and financial structuring that is prearranged for each customer in addition to accelerated invoice settlement,

35. A service model for automatically customizing the implementation of a financing on demand transaction over a network, the service comprising:
an automatic generation of a customer's entitlement;
an automatic creation of a master agreement transaction; and
an automatic notification of a financing company and a merchant of a customer's credit approval,
to provide enhanced ease of product sales through greatly expanded credit access and financial structuring that is prearranged for each customer in addition to accelerated invoice settlement,
